(19) United States
(12) Patent Application Publication
(10) Pub. No.: US 2007/0058848 A1
(43) Pub. Date: Mar. 15, 2007

(54) Method of determining and correcting non-linear detector pixels

(76) Inventors: Uwe Heike, Rellingen (DE); Klaus Bavendiek, Norderstedt (DE)

Correspondence Address: GRAYBEAL, JACKSON, HALEY LLP, 155 - 108TH AVENUE NE, SUITE 350, BELLEVUE, WA, 98004-5901, US

(21) Appl. No.: 11/503,430

(22) Filed: Aug. 10, 2006

(30) Foreign Application Priority Data
Aug. 10, 2005 (DE) DE102005037 894.3

(51) Int. Cl. G06K 9/00

(52) U.S. Cl. 382/128

(57) ABSTRACT

A method of determining and correcting non-linear detector pixels by: recording a test image illuminated by X-ray beams with a detector constructed pixel by pixel; performing offset correction and gain correction of the recorded test image to establish a corrected test image; filtering the corrected test image with a suitable filter; calculating the difference between the filtered test image and the corrected test image; identifying as non-conforming all pixels in the difference calculation whose grey levels are outside predeterminable thresholds; and classifying the non-conforming pixels as non-linear detector pixels. For improved displays, the non-conforming pixels can be visually represented with a gray scale value the same as, or similar to, that of an adjacent display pixel that corresponds to a conforming detector pixel.

### CROSS-REFERENCE To RELATED APPLICATION

Priority under 35 U.S.C. §119(a) to German patent application number DE 10 2005 037 894.3, filed 10 Aug. 2005, is claimed, said application being incorporated herein by reference.

### BACKGROUND OF THE INVENTION

The invention relates to a method of determining and correcting non-linear detector pixels in a detector for X-ray beams.

It happens with X-ray beam detectors, constructed pixel by pixel, that individual pixels or even entire rows or columns of pixels are defective and, thus, disruptively drop out from the properly recorded values of the surrounding pixels. Thus, such non-linear detector pixels have frequently been ignored and the resultant disruptive effects on the screen on which an X-ray picture is represented is simply accepted. However, because of their brightness or darkness, such non-linear pixels permanently disturb the otherwise even image impression. Sometimes, such non-linear detector pixels have also been manually included in a “bad pixel list”.

A method of operating a digital image system of an X-ray diagnostic device is known from DE 195 27 148 C1. This has an X-ray unit for creating X-ray images. It also has an X-ray image converter-television string for recording the X-ray images, which has a digital image converter with picture elements arranged in matrix form in rows and columns and a monitor to reproduce the X-ray images processed by the digital image system. To recognize defective picture elements, at least one calibration image is converted into a filter image by a high pass filtering, for example a median filtering, which is fed to a defect-determination device so that a defective image is obtained which is used to correct an original image.

An X-ray examination device and a method of creating an X-ray image are known from DE 100 19 955 A1. The device has a processing unit for correcting image data. In order to automatically correct image errors which are caused by imperfections in the image creation and processing string there is an error-detection unit for the detection of image errors, situated downstream from the processing unit. These can be detected using image parameters which can be extracted from image data found during clinical studies and which are suitable for adapting processing parameters used in the processing unit depending on the detected image errors. To detect image errors which are caused in particular by defective sensor elements, or pixels of the X-ray detector, a filter unit is provided, by means of which an error table for defective sensor elements is drawn up on the basis of a threshold value. Using this error table, a correction table is drawn up in the processing unit and applied to the image data.

A method of operating an image system of an imaging medical examination device and an associated medical examination device are known from DE 101 22 876 A1. The image system has a receiving unit for receiving several signals coming from different locations and a display unit for the imaging representation of picture elements. At least one signal is allocated to each of the picture elements. A defect determination for determining any defective picture element present in the image is carried out in respect to an event of the undisturbed operation of the medical examination device and a correction process then automatically activated. Within the framework of the defect determination, after carrying out a first correction procedure in which already known image defects are corrected, the corrected image is analyzed to determine further or still-present defects, which are corrected in a second correction procedure.

### SUMMARY OF INVENTION

The embodiments of the invention are intended to make available a further method with which the non-linear detector pixels are automatically recognized.

The first step of a method according to the invention is to record a test image. The recording can take place in any X-ray detector arrangement as long as the detector is constructed pixel by pixel. The recording by a detector constructed pixel by pixel of a test image evenly lit by X-ray beams is well enough known to an average person skilled in the art so as not to require description in further detail here.

In a second step, the test image undergoes an offset correction and a gain correction. Both offset correction and gain correction are types of correction thoroughly familiar to a person skilled in the art, and so need not be described in more detail in this context.

In the third step, a filtering of the corrected test image with a suitable filter, e.g. a median filter, takes place. Filtering by means of a median filter is known in principle; the filter classifies the grey levels of the pixels inside the filter mask using the size of the grey levels and then selects as the result the grey level in the middle of the range. The size of the filter mask of the filter is chosen according to the quality of the gain correction and the noise of the test image and the expected size of a cluster of non-linear pixels. A larger filter mask involves more dots in the filtering; a better smoothing is thereby achieved so that the method also operates with grainy images or suboptimal gain corrections. Furthermore, with larger filter masks several coherent non-linear pixels can also be determined. However, larger filter masks clearly require more computing time.

In the fourth step a difference is determined between the filtered test image and the corrected test image. This determination step is thoroughly familiar to a person skilled in the art and is therefore not described in more detail at this point.

In the following, fifth step, all the pixels which have a grey level lying above a predeterminable upper threshold or below a predeterminable lower threshold are determined in a difference image. Thus all the pixels which have a grey level outside a grey level lying around a predeterminable average value are thereby determined. As the test image is preferably evenly lit, theoretically all the pixels of the detector must have the same grey level. However, because of manufacturing tolerances and the geometric design of the X-ray detector arrangement, a degree of spread of grey levels is unavoidable even with an absolutely evenly lit test image. However, all the pixels outside a predeterminable tolerance range—which is defined by the predeterminable upper threshold and the predeterminable lower threshold—are to be seen as disruptive non-linear detector pixels and are considered non-conforming.

In the final, sixth step, the pixels of the detector that lie outside the above-stated tolerance range of the grey level (the non-conforming pixels) are therefore classified as non-linear detector pixels. This means that—unlike with the costly manual inclusion known from the state of the art of the non-linear detector pixels in a “bad pixel list”—all the non-linear detector pixels are automatically recorded and stored. Thus, for each image recorded by the X-ray detector arrangement, it is clear in the following operating mode which pixels make an incoherent contribution (the non-linear detector pixels) and which pixels correctly reproduce the recorded item.

An advantageous development of the invention provides that in subsequent pictures of testpieces, the grey levels of the pixels classified as non-linear detector pixels are always matched to the grey levels of the adjacent or proximate detector pixels. It is thereby possible that, to the observer of the pictures, no disruptive individual pixels or entire rows of pixels or columns of pixels stand out from the picture and make the assessment of the picture difficult. The observer is thus not deflected from the search for artifacts in the picture. Thus a better and more reliable checking of the pictures of testpieces is made possible.

In summary it can be said that through the above-represented sequence of steps the invention makes it possible to determine all the non-linear detector pixels while operating at very little cost. The threshold can be chosen when a non-linear detector pixel is assumed, such that in an individual case it can be matched to the respective X-ray detector arrangement.

Through a further development of the invention, it is then also possible to match the grey levels of the non-linear detector pixels previously automatically determined according to embodiments of the invention to the environment of every single non-linear detector pixel, such that for the observer of a picture of a testpiece, the non-linear detector pixels are no longer even visible and he is thus not deflected from a correct evaluation of the recording as regards the presence of artifacts.

What is claimed:

1. A method of determining and correcting non-linear detector pixels comprising:
recording a test image illuminated by X-ray beams with a detector constructed pixel by pixel;
performing offset correction and gain correction of the recorded test image to establish a corrected test image;
filtering the corrected test image with a suitable filter, wherein the size of a filter mask of the filter is chosen according to at least one of the quality of the gain correction, the noise of the test image, or the expected size of a cluster of non-linear pixels;
calculating the difference between the filtered test image and the corrected test image;
identifying as non-conforming all pixels in the difference calculation whose grey level lies above a predeterminable upper threshold or below a predeterminable lower threshold; and
classifying the non-conforming pixels as non-linear detector pixels.

2. The method according to claim 1, characterized in that the grey levels of the pixels classified as non-linear detector pixels are matched to the grey levels of detector pixels adjacent or proximate thereto.
